(19) United States
(12) Patent Application Publication
(10) Pub. No.: US 2009/0298704 A1
(43) Pub. Date: Dec. 3, 2009

(54) Wireless CMOS Biosensor

(76) Inventors: M. Mekhail Anwar, Cambridge, MA (US); Paul Matsudaira, Newton, MA (US); Aytur Turgut, Plattsburgh, NY (US)

Correspondence Address: Pearl Cohen Zedek Latzer, LLP, 1500 Broadway, 12th Floor, New York, NY, 10036, US

(21) Appl. No.: 11/988,473

(22) PCT Filed: Jul. 12, 2006
(86) PCT No.: PCT/US2006/026830

§ 371 Date: Jul. 22, 2009

Related U.S. Application Data
(60) Provisional application No. 60/698,883, filed on Jul. 12, 2005.

(51) Int. Cl. C40B 30/04; C40B 60/12

(52) U.S. Cl. 506/9; 506/39; 977/774

(57) ABSTRACT

System and methods for detection and measurement of interactions in microarrays or within a human body are described. The system includes a CMOS sensor which can be placed in a fluidic environment, and is capable of measuring DNA interactions and protein binding kinetics, as well as cellular interactions and signals within the body. The sensor can be placed in close proximity with the sample and eliminates the need for optics, and in some embodiments is a wireless device.

### FIELD AND BACKGROUND OF THE INVENTION

The study of biology is progressing towards systems-based biology, where the entire space of gene activation and/or protein function is analyzed. To achieve this, the use of DNA and protein arrays, such as microarrays, has become widespread. In addition, the in-vivo sensing of cellular behavior and reactions provides important information in the study and treatment of various conditions.

Nearly all forms of biosensors utilize a biological entity (i.e. antibody, protein, DNA, drug, etc) to interface with the target (i.e. ligand: virus, receptor, protein, bacteria, etc). An instrument is then used to read that reaction, and relay its results to the outside world. This is traditionally accomplished with an external device. These devices read signals such as light (from fluorescently labeled entities), radioactivity, mass, electric charge etc. These devices tend to be large and expensive. Additional approaches to reading microarrays are needed.

### SUMMARY OF THE INVENTION

The present invention relates to a wireless complementary metal oxide semiconductor (CMOS) imager that is useful for microarray imaging (such as protein and DNA microarrays) as well as for implantable sensors.

According to one aspect of the present invention, there is provided a system for identifying a biological sample. The system includes a sensor having at least one photodiode for converting photons obtained from interaction with the sample into electrons and for providing analog electrical output; an analog to digital converter in electrical communication with the photodiode for converting the analog output into a digital signal, wherein at least the photodiode and the analog to digital converter form a CMOS circuit, and a processor for processing the digital signal.

According to another aspect of the present invention, there is provided a sensor for identifying an interaction in a microarray. The sensor includes a pixel array of photodiodes wherein a size of each pixel of the pixel array is less than 150 micrometers. In some embodiments, a size of each pixel ranges from less than the size of a spot on the microarray to a maximum of the pitch between spots on the microarray. In some embodiments, the size of each pixel is less than twice the size of a spot on the microarray. In some embodiments, an outer layer substantially surrounds the pixel array, wherein the outer layer provides a fluid barrier between electrical components of said sensor and said biological sample.

According to another aspect of the invention, there is provided a method for measuring a sample. The method includes providing a wireless CMOS biosensor having a pixel array of photodiodes, providing a microarray of the biological sample, wherein the microarray has a one-to-one correspondence with the pixel array, tagging the biological sample with a fluorescent label, placing the biosensor proximal to the microarray, illuminating the biosensor and the biological sample, wherein the illuminating causes the tagged biological sample to emit photons, converting the photons into an electrical signal using the CMOS biosensor, and wirelessly receiving the electrical signal, wherein the electrical signal is representative of an amount of tagged biological sample.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a block diagram illustration of a system for identifying a sample, in accordance with embodiments of the present invention;

FIG. 2 is a planar view diagrammatic illustration of biosensor chip from the system of FIG. 1, in accordance with embodiments of the present invention;

FIG. 3 is a diagrammatic illustration of a pixel from the chip of FIG. 2, in accordance with embodiments of the present invention;

FIG. 4 is a block diagram illustration showing the various components of a sensor and processor from the system of FIG. 1;

FIGS. 5A and 5B are circuit diagrams for a sensor photodiode and reference photodiode from the pixel of FIG. 3;

FIG. 6 is a circuit diagram illustration of an amplifier for use with the chip of FIG. 2, in accordance with embodiments of the present invention;

FIG. 7 is a circuit diagram illustration of an analog to digital converter for use with the chip of FIG. 2, in accordance with embodiments of the present invention;

FIG. 8 is a graphical illustration of a clock signal that is generated from the sine wave of a wireless interface from the system of FIG. 1;

FIGS. 9A and 9B are diagrammatic illustrations of a light source in accordance with embodiments of the present invention;

FIG. 10 is an illustration of direct UV illumination of a commercial CMOS camera using Qdots;

FIG. 11 is a calibration curve showing the number of photons incident on a sensor of the present invention versus applied voltage;

FIG. 12 is a graphical illustration of pixel output from ramping LED voltage;

FIGS. 13A and 13B are graphical illustrations of amplifier output versus incident light;

FIG. 14 is a graphical illustration of digital values from amplifier output;

FIG. 15 is a graphical illustration of differential output with noise; and

FIG. 16 is a graphical illustration comparing varying concentrations of GFP using the CMOS sensor of the present invention versus a CCD camera.

### DETAILED DESCRIPTION

In the following detailed description, numerous specific details are set forth in order to provide a thorough understanding of the invention. It will be understood by those of ordinary skill in the art that the present invention may be practiced without these specific details. In other instances, well-known methods, procedures, components and structures may not have been described in detail so as not to obscure the present invention.

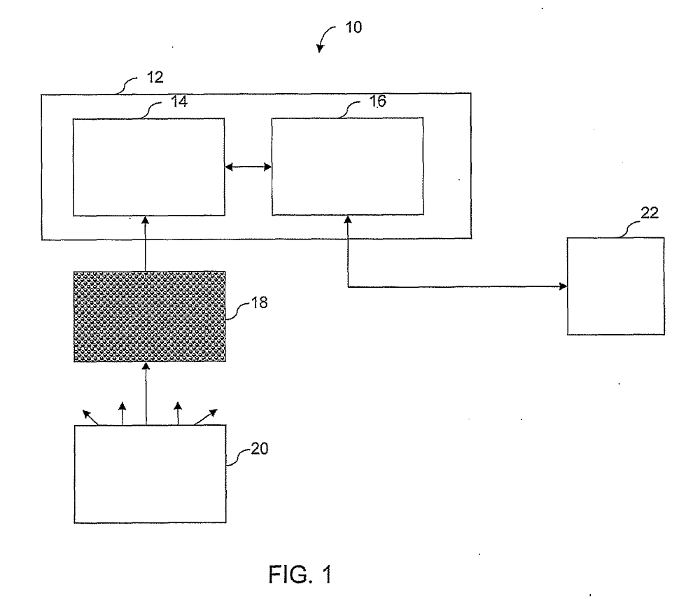

Reference is now made to FIG. 1, which is a block diagram illustration of a system 10 for identifying a sample, in accordance with embodiments of the present invention. System 10 includes a biosensor chip 12 having a sensor 14 and a processor 16, a sample 18 to be analyzed, a light source 20 and a wireless interface 22. Sample 18 is positionable in contact with or in close proximity to biosensor chip 12, both of which may be illuminated by light source 20. The proximity of sample 18 to chip 12 is dependent on the spot size of sample 18 and may be, for example, within a distance which is several times the spot size. Sensor 14 senses and converts photons emitted by sample 18 into electrical current, and processor 16 processes signals associated with the current to provide data output. Most or all of the individual components of processor 16 are positioned on the chip itself and comprise a CMOS circuit. Wireless interface 22 provides power and a clock to chip 12, and receives data output from processor 16.

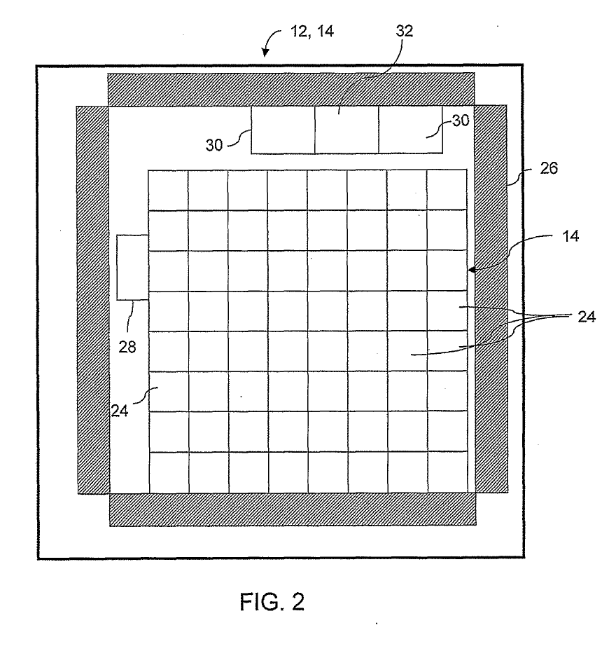

Reference is now made to FIG. 2, which is a planar view diagrammatic illustration of biosensor chip 12, in accordance with embodiments of the present invention. In one embodiment, chip 12 is a rectangular chip which is positionable in close proximity to sample 18. In one embodiment, chip 12 is approximately 3×3 mm in size. It should be readily apparent, however, the chip 12 may be any size suitable for imaging and sensing microarrays or biological in-vivo interactions. Chip 12 is comprised of an array of pixels 24, and processor components including a voltage rectifier and regulator 28, and an analog to digital converter 30. Chip 12 further includes an antenna which is configured to communicate with an external reader. In one embodiment, the antenna is comprised of inductor coils 26. Inductor coils 26 comprise a wireless interface 22, and operate to generate the power and clock signal from the RF wave and to send received digital data to the external reader. Additional processor components are further included on each pixel, as will be described in greater detail hereinbelow. In embodiments of the present invention, pixels 24 are designed and sized to directly correspond to a microarray having samples therein for analysis. For example, the size of each pixel is designed to correspond to the size of each sample in a microarray. Each pixel is within a multiple of the size of the sample, where the upper limit is the pitch of the array spots, and the lower limit is the size of the spot itself. Thus, for example, if each spot is 100 micrometers, and is separated from the next spot by 200 micrometers, the pixel could range from 100-300 micrometers. In one embodiment, the pixels are less than 150 micrometers. In some embodiments, the pixels are approximately 120×120 micrometers in size. In some embodiments, the size of each pixel is less than twice the size of a spot on the microarray. In the embodiment shown herein, the pixel array is a 64-pixel array. It should be readily apparent that other configurations are possible and are included within the scope of the invention. Chip 14 may further include an outer layer providing a fluid barrier between electrical components of chip 14 and sample 18. This is possible due to the wireless interface 22, which will be described in greater detail further hereinbelow, and further allows for chip 14 to be implantable in a human body. In one embodiment, the outer layer is a biocompatible material, such as a biocompatible polymer.

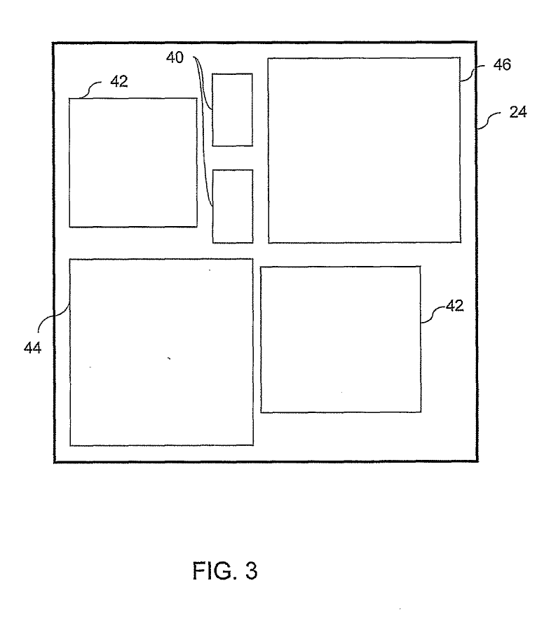

Reference is now made to FIG. 3, which is a diagrammatic illustration of a pixel 24 in accordance with embodiments of the present invention. Pixel 24 includes a sensor photodiode 44 and a reference photodiode 46, in electrical communication with source followers 40 and hold capacitors 42. Hold capacitors 42 may be any size suitable for pixel 24, and are generally chosen to be the largest capacitors that will fit into the designated space on pixel 24. In one embodiment, hold capacitors 42 are 50 pF poly-poly capacitors. Sensor photodiode 44 is a photodiode typically used in a CMOS circuit, and may be, for example, all N-plus P-sub diode, an N-well P-sub diode, a P-plus N-well P-sub diode, an N-plus P-well diode or any other suitable photodiode. In some embodiments, different pixels within the pixel array have different diodes. In one embodiment, three rows of pixels are comprised of N-plus P-sub diodes, three rows of pixels are comprised of N-well P-sub diodes, and the remaining two rows of pixels are comprised of P-plus N-well P-sub diodes. It should be readily apparent that such configurations are exemplary and that many other combinations of diode types are possible and are included within the scope of the invention. Reference photodiode 46 is a photodiode which is covered with a metal to measure the dark current. Sensor photodiode 44 and reference photodiode 46 are placed as far away from each other as possible to avoid carriers from one “leaking” to the other. Outputs from sensor photodiode 44 and reference photodiode 46 are subtracted to eliminate noise from the pixel and in one embodiment are laid out in a common centroid arrangement. This configuration provides for a fully differential pixel architecture which can compensate for the high noise level which may occur due to the wireless interface.

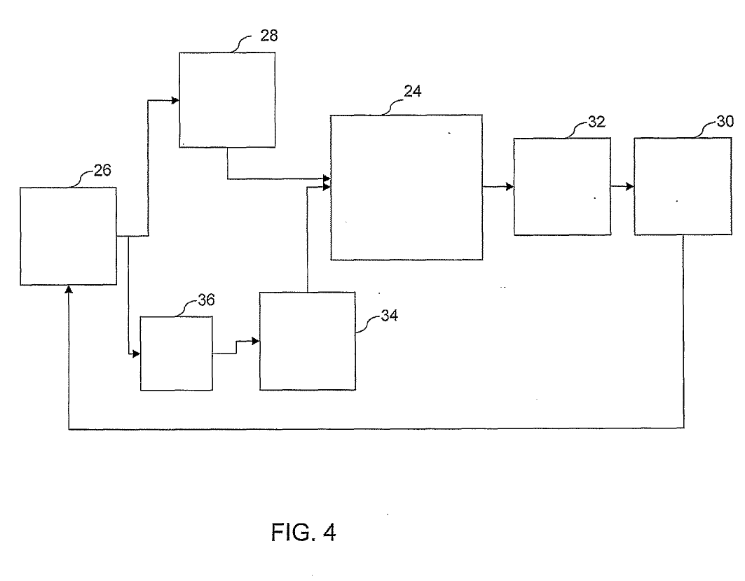

Reference is now made to FIG. 4, which is a block diagram illustration showing the various components of sensor 14 and processor 16, and how they are interrelated. An inductor coil 26, located on chip 12, provides an RF signal to a clock generator 36, which generates a pulse and sends it to a clock and decoder 34, positioned on chip 12. Clock/decoder 34 divides the signal by any chosen number (equaling the number of bits of resolution needed). Clock/decoder activates each pixel 24 serially for readout, and the readout signal is amplified by amplifier 32, and sent to analog/digital converter 30. Analog to digital converter 30 uses clock 34 to derive the digital conversion for the analog signal. Any implementation of an analog to digital converter can be used. In this embodiment, the integrating current is set by a switch capacitor circuit whose clock is governed by the clock from the RF signal, thus making the analog to digital converter, which samples the output from amplifier 32 and integrates until a threshold voltage is reached. The time it takes for the threshold to be reached is recorded by latching the value of the clock. This becomes the digital signal. The integrating current is derived from the power supply, and is based off of a switch capacitor circuit, so that the analog to digital converter is frequency independent (i.e. the higher the frequency, the larger the current, and the shorter the time). The final signal is then sent back to inductor 26.

The standard CMOS photosensor design is a traditional three transistor design whereby an NMOS reset transistor charges the photodiode (and associated parasitic capacitance) to V_{dd}−Vₜ where V_{dd} is a power supply voltage, and Vt is the threshold voltage of the reset transistor. The reset transistor is turned off, and the photodiode converts photons to a current which discharges the parasitic capacitance. Because the depletion region capacitance is a function of the reverse bias, the parasitic capacitor functions as a non-linear gain element. During readout, the row/column switch is activated, and the source follower reads out the voltage on the photodiode. This voltage is amplified, and converted to a digital signal. After readout, the reset transistor is activated, the photodiode voltage is reset, and the process repeats. Pixels can be selectively read out by using a select transistor. Frequently, the readout circuitry utilizes correlated double sampling (CDS) to reduce fixed pattern noise, such as amplifier offsets. In addition, depending on the power, speed, and noise requirements, the amplifier and A/D can be located at the chip level, row/column level, or even at the pixel level. In the present application, a slightly modified design is used. Each photodiode is connected to a PMOS reset transistor instead of the traditional NMOS, because the area is not limiting, and the photodiode can be reset to V_{dd}. In addition, image lag can be reduced by using a PMOS reset transistor.

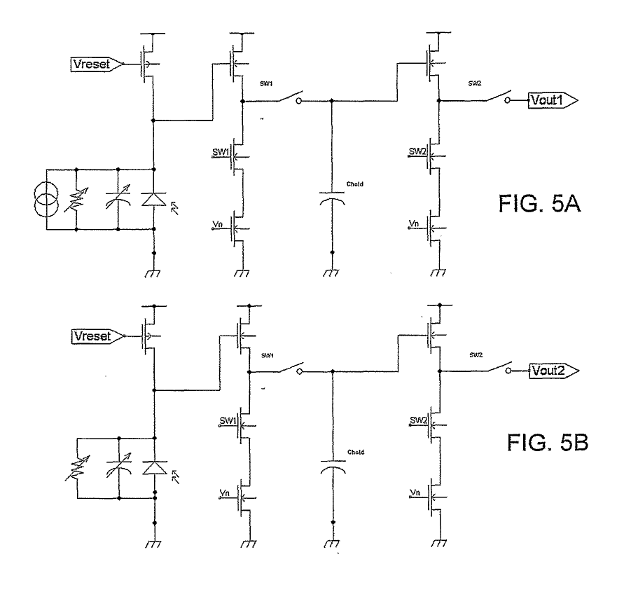

Reference is now made to FIGS. 5A and 5B, which are circuit diagrams for the sensor photodiode and reference photodiode, respectively. Briefly, sensor photodiode 44 (or reference photodiode 46, as shown in FIG. 5B) is connected to a voltage source via a PMOS device. This allows sensor photodiode 44 to have a rapid and complete reset, eliminating image lag. The photodiode current draws current off of the parasitic capacitance, causing a decrease in voltage in response to light. The output from sensor photodiode 44 is buffered by first source follower 40, which has a switch to eliminate power consumption when not in use. The output is stored on hold capacitor 42 and can be read out at a later time by second source follower 41. The small signal output of the pixel is,

$${v}_{0} = \frac{P φ}{{C}_{ph}} {A}_{sf}^{2} ,$$

where P is the incident photons per second, Cₚₕ, is the photodiode parasitic capacitance, φ is the quantum efficiency, and A_{sf}, is the source follower gain (˜0.8). Second source follower 41 then reads the stored voltage and transmits it to the analog to digital converter 30. This is a serial operation. The pixel can also operated in a mode where both source followers are activated simultaneously, and there is no sample and hold operation.

Due to the presence of a wireless interface, power must be conserved, while achieving the necessary sensitivity and speed. As an example, a fixed power budget of 150 μAmps×1.5V⁶ may be used for all other design considerations. In one embodiment, a single amplifier is used for the entire chip and as such, the pixels must be serially converted to a digital value and output. A method of illumination referred to as “light modulation” is now described. In order to use light modulation, each pixel must integrate during the same time period (i.e. when the light is on, or the light is off). Therefore, each pixel must have memory so that the value of each pixel can be stored at the end of the cycle, and then serially read out and converted to a digital value. The operation of each pixel 24 is as follows.
1. The illuminating light is turned on for time tᵢₙₜ.
2. All pixels 24 integrate the current generated by sensor photodiode 44 plus the dark current measured by reference photodiode 46.
3. At the end of tᵢₙₜ, the light is turned off. Simultaneously, on all pixels, first source follower 40 samples the photodiode voltage and stores it onto hold capacitor 42.
4. The light is kept off for tᵢₙₜ, and the photodiodes continue to integrate dark current. During this time, the values on hold capacitors 42 are serially decoded. Second source follower 41 is turned on, and the voltages on hold capacitor 42 (from both the reference and sensor photodiodes) is transferred to a differential amplifier 32. The amplifier output is then sent to the analog to digital converter 30. The digital output is then stored in a shift-register. If the digital output or amplifier output indicates that the analog to digital converter is reaching its dynamic range limits, a reset signal is sent via reset transistor to pixel 24. Therefore each pixel can operate independently, and only resets when necessary.
5. After the pixel has been decoded, the process repeats for the next pixel. During the next pixel's conversion process, the previous pixel's digital data is modulated at some amount less than the clock frequency,

$$\frac{{f}_{clk}}{2} ,$$

and sent out via the inductor coil.

A calibration routine compensates for the non-linear gain of amplifiers and of the parasitic capacitance of the photodiode. In one embodiment, chip 12 is illuminated with a constant light source, wherein the change in voltage as a function of time should be constant. By recording the digital output during this process, data is calibrated off-line to remove non-linearities. In another embodiment, one pixel comprises only the reference pixel, and in place of the light sensing pixel a capacitor is used. This pixel will only (differentially) measure the dark current, which is assumed to be constant, as its only dependence is on temperature. In another embodiment, a current source can be used instead of the dark current. The output from this constant current input is recorded, and used to calibrate the amplifier and analog to digital converter.

### Amplifier

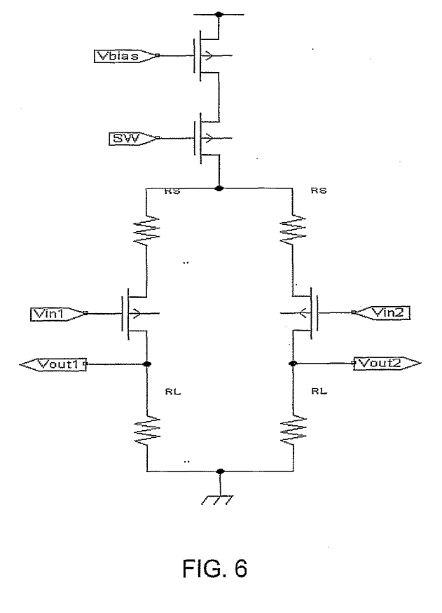

Amplifier 32 is positioned on chip 12, and receives output from each of pixels 24. In another embodiment, separate amplifiers are used for each pixel. Reference is now made to FIG. 6, which is a circuit diagram illustration of amplifier 32, in accordance with embodiments of the present invention, The particular design shown in FIG. 6 was chosen based on its simplicity, linearity and insensitivity to temperature variation. However, it should be readily apparent that many other designs are possible, and that any suitable amplifier may be used. The amplifier is open loop to allow for simplicity of design, and high gain and speed with minimal power consumption. The amplifier uses a resistor at the source of the input transistors to eliminate temperature effects on the gain characteristics, and to linearize the gain. This limits output swing, and reduces the gain.

In another embodiment, the source resistor is eliminated, and a calibration scheme is employed to adjust the nonlinear gain. The calibration pixel has the photodiode that is exposed to light replaced with a capacitor. The remaining covered photodiode only draws dark current. The dark current is constant (as long as the temperature is stable), and this provides a constant current (equivalent to constant light) input to the amplifier and analog to digital converter. The digital circuitry, which typically advances to the next pixel after the current one is finished with the analog to digital conversion, stays on the calibration pixel for a set number of cycles. This allows the input voltage to be ramped (due to the constant current of the dark current) and sweep the amplifier and analog to digital converter. This cycle repeats several times to get a good calibration, and allows for correlation of the output digital value with the amount of charge at the input. The digital circuitry activates the calibration at pre-set intervals to allow recalibration during data acquisition.

### Analog to Digital Converter

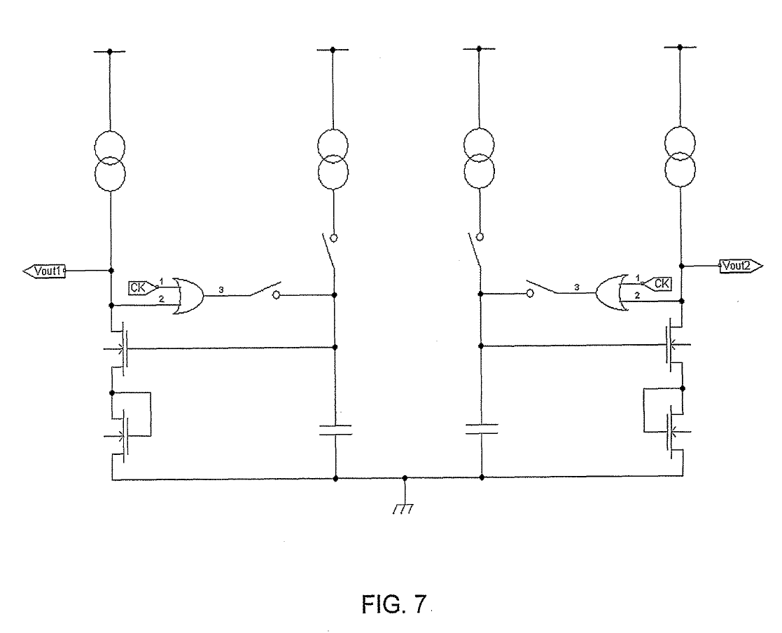

Reference is now made to FIG. 7, which is a circuit diagram illustration of an analog to digital converter, in accordance with embodiments of the present invention. However, it should be readily apparent that many other designs are possible, and that any suitable analog to digital converter may be used. The output of the amplifier is sampled onto the input capacitor. After sampling for tₛₑₜₜₗₑ, a current source then charges the capacitor until the NMOS FET is turned on. This switches the output from 1 to 0, and the inverters buffer the output and clean up the signal. This threshold voltage is set at an integer number of threshold voltages (depending on the number of diode connected transistors). The current source is designed so that it can charge the capacitor to the necessary voltage in the time allotted. When the voltage on the capacitor reaches the threshold voltage of the converter, the output of the converter switches, and the value of the counter is latched into an array of flip flops. The resolution of the analog to digital converter depends on how many clock bits are saved. In one embodiment, there are 12 clock bits during tₛₑₜₜₗₑ, and the resolution is given by equation 19.

$$Δ V = \frac{{V}_{R}}{{2}^{n} bits} \qquad ( 19 )$$

In another embodiment, all circuits are threshold voltage referenced so as to avoid offset between the amplifier common mode output voltage and the range of the analog to digital converter. The bias current source for the amplifier is set by I=Vt/Rstartup, where Rstartup is the startup resistor. The common mode output voltage is then I×Rload, which is Vt×(Rload/Rstartup). Therefore, variations in sheet resistance will cancel out. Furthermore, to allow for varying frequencies (the integration time goes as 1/f), the current sources is a mirror of a switch capacitor current source, which allows the current to vary linearly with f, so that the integration is independent of f.

### Wireless Interface

The wireless interface serves to provide power input and clock generation, and to collect data output. Wireless interface 22 comprises an antenna, such as inductor coil 26 made of any combination of metal or other conductive layers, voltage rectifier, voltage regulator, and clock generator. Inductor coil 26 can be an integrated inductor coil, (for microarray applications), or an external inductor coil (for implantable applications). In cases where inductor coil 26 is an external inductor, it can be bonded to the chip, and may further be embedded in an outer layer. For implantable applications, the external inductor may be in contact with a stent or other implantable device, or the device {i.e. stent} itself may act as the inductor. Inductor coil 26 is designed so that its resonant frequency is near the needed clock frequency of the chip. In one embodiment, the chip uses a 30 loop, square coil with 4 μm width, and 1 μm spacing. The metal 3 layer is only 2 μl wide to reduce capacitance. It should be readily apparent that the specific parameters may vary with chip size and manufacturing process. Inductor coil 26 connects to a rectifier and is connected between RFP and RFN. The rectifier is diode clamped to ensure that high voltages do not affect circuitry on chip. The series of diode connected FETs are designed to ensure that voltage on the coil does not get too high and destroy the chip. The FETs used may be double gate FETs, which should better shield the circuitry from high voltages. The signal from the rectifier, V_{DD}, then feeds into voltage regulator 28. Voltage regulator 28 supplies approximately 200 μL Amps, at 1.5V, and additionally provides several reference voltages.

In another embodiment, the diode clamps are made with high threshold voltage devices to shield the clamp itself from high voltages. In some embodiments, separate power supplies are used one for the analog and one for the digital circuitry, to avoid noise coupling. Each power supply has its own inductor, rectifier and voltage regulator. In some embodiments, all of the components are integrated on the chip. Inductor 26 loops around the chip. In cases where two coils are used, the inductor coils may be concentric. In some embodiments, multiple coils are used, wherein the power contribution from each of the multiple coils can be summed.

In one embodiment, wireless interface 22 is used to power an external LED for visualization of smaller intracellular features, or optical density measurements.

### Digital Circuitry

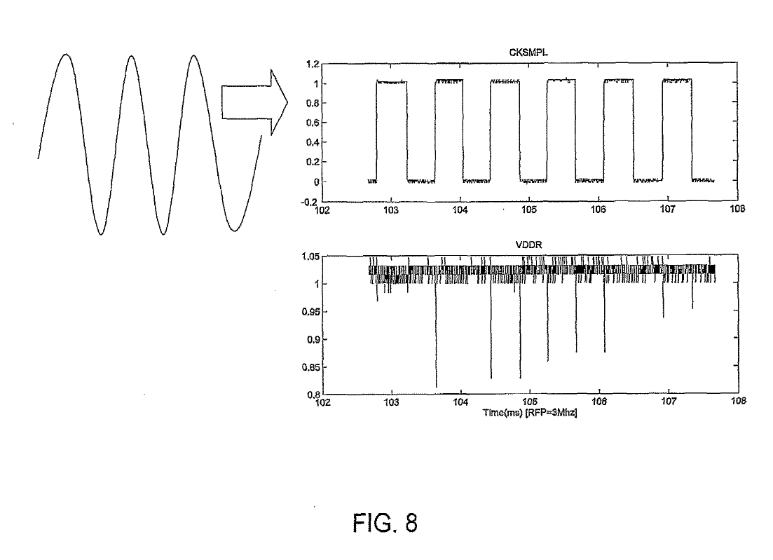

Reference is now made to FIG. 8, which is a graphical illustration of a clock signal that is generated from the sine wave (RF). A digital block called RESBLK outputs a signal called RESB. This signal is a logic 0 when the chip begins to power up. When V_{DDR}, the regulated voltage output, reaches a predetermined number of threshold voltages (for example, ≈3Vₜ). RESB becomes a logic 1, and the digital circuitry on the chip is activated. Much of the digital circuitry begins to function only when RESB=1, preventing high power loss intermediate states in the logic circuits. The CKGEN circuit block generates the clock signal. The RF signal from the coil is passed to a capacitive voltage divider, which then feeds into a series of inverters. The clock signal is at the same frequency of the RF signal. The clock is then divided down by a series of D-flip-flops to provide the counter. The memory elements are a series of flip flops that load data in parallel, and then serially shift it out. Power consumption is large in blocks that contain rapidly switching D-flip-flops (i.e. the counter) because of the momentary path from V_{DD} to GND as the states switch. The TX circuit block is responsible for the transmission of data. During readout, the bits are passed to the TX block. The bits are then multiplied by a digital signal that is 1/N times the frequency of the clock (where N=integer). Thus the data is modulated at fclk/N, and can be separated from the excitation RF signal via a low pass filter.

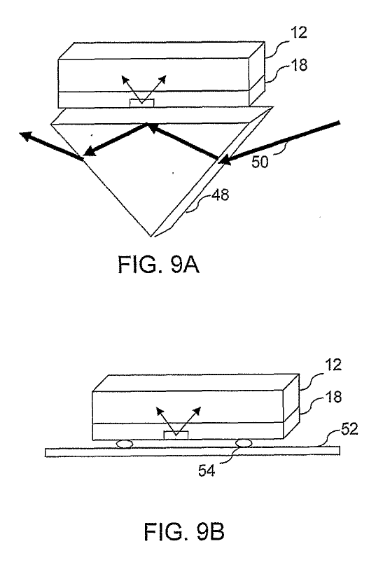

Reference is now made to FIGS. 9A and 9B, which are diagrammatic illustrations of a light source in accordance with embodiments of the present invention. Light source 20 is configured to provide light to sample 18 and chip 14. One goal of the present invention is to eliminate the need for lenses by placing the sensor adjacent to the sample surface, so that the emitted light cannot spread too far before it intersects the sensor. Therefore a lens is not needed to gather the light. To implement this, the pixel must be as large or larger than the imaging spot (for maximum signal), and must be on the order of the spot size (for example, if the spot is 100 micrometers, the sensor should be between 0 and several hundred micrometers away from the surface). The maximum pixel size is dictated by the spot size and pitch. Furthermore, by eliminating bond wires (via wireless interface, as shown in FIG. 9A, or via use of flip chip bonding, as shown in FIG. 9B), the sensor may be placed extremely close to the surface, maximizing signal reception. As shown in FIG. 9A, chip 12 is placed in close proximity to sample 18. In one embodiment, chip 12 is in contact with sample 18. In another embodiment, chip 12 is within a few micrometers of sample 18. The proximity of sample 18 to chip 12 may be dependent on the spot size of sample 18 and may be, for example, within a distance which is several times the spot size. Light detection side of chip 12 faces sample 12. In this embodiment, all bond wires have been eliminated, and a wireless interface is present. In cases where a wireless interface is not included bond wires can be avoided by using flip-chip bonding, as shown in FIG. 9B. In this embodiment, as in the embodiment shown in FIG. 9A, chip 12 is placed in close proximity to sample 18. In one embodiment, chip 12 is in contact with sample 18. In another embodiment, chip 12 is within a few micrometers of sample 18. However, a thin transparent substrate 52 is placed beneath sample 18, and metallic connecting element 54 connects chip 12 to a processor, such as a PC board. In one embodiment, substrate 52 is a glass cover slip with microfabricated wire traces. In another embodiment, substrate 52 is a flexible polymer. In one embodiment, metallic connecting element 54 is gold, and may be a ball or bump. In another embodiment, metallic connecting element 54 is a lump of solder.

In one embodiment, light source 20 is a prism 48 configured to provide evanescent lighting. Traditional imaging systems (epi-fluorescent) utilize filters and lenses to guide light to the sample and focused the re-emitted light. By implementing an evanescent system of illumination, the sample can be illuminated from underneath, allowing for the imaging sensor to be placed close to the surface. Evanescent lighting allows for measurement of binding kinetics, which is important for protein microarrays. In this embodiment, sample 18 is patterned on a transparent substrate, such as glass or plastic. The substrate with the sample inside is placed on the top, flat surface of prism 48. Light, depicted by arrows 50, is directed into the prism at an angle such that a layer approximately 50 nm (approximately 1/10^{th} of the wavelength) above the surface is illuminated. The minimum angle is determined by the critical angle, which is

$${θ}_{c} = arcsin ( \frac{{n}_{2}}{{n}_{1}} ) ,$$

where n1 is the index of refraction of the prism, and n2 is the index of refraction of the medium {i.e. our sample, or water} thetaC is given with respect to the normal (i.e. the perpendicular line going through the surface of the prism). This light causes sample 18 to be illuminated with an evanescent wave. Light detection side of chip 12 is positioned adjacent to sample 18, and light emitted from sample 18 is transmitted to sensor 14. This configuration allows for samples which are close to the surface to be illuminated, while those greater than a few tens of nm away are not.

An additional way to eliminate optical components, such as filters, is by the use of quantum dots instead of fluorophores. Quantum dots can be conjugated to DNA or protein, and/or used as a secondary label. Typical fluorophores absorb and reemit light with a Stoke's shift of typically between 15 and 30 nanometers. In order to separate the excitation light from the emitted light, an optical filter is needed. Quantum dots, however, absorb exceedingly well at deep UV wavelengths and emit at a constant visible wavelength, while silicon absorbs UV light poorly. Thus, if a quantum dot is used as a marker instead of a fluorophore, UV light can be used as the excitation light, and no optical filter is needed since the silicon cannot “see” the UV light. The quantum dot will emit a visible wavelength of light, which can be detected by the CMOS sensor. An additional advantage of quantum dots is that they do not bleach, allowing long integration times to see extremely small signals. Quantum dots are available from www.qdots.com, and can be conjugated with a variety of proteins (i.e. streptavidin) or functionalized chemical linkers, (i.e. Nh2 or COOH).

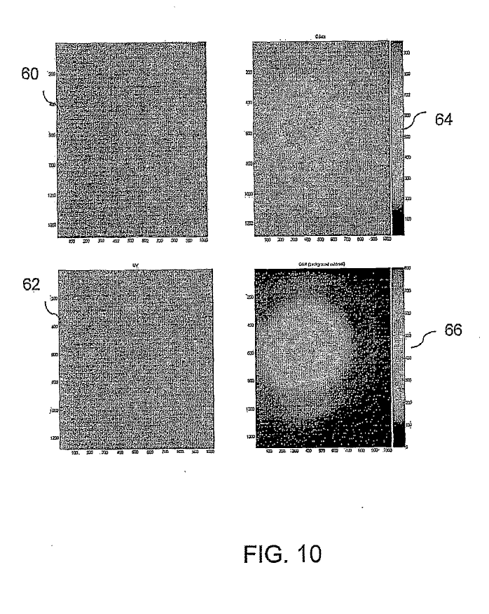

Reference is now made to FIG. 10, which is an illustration of direct UV illumination of a commercial CMOS camera. Results are shown for no illumination (frame 60), illumination with UV light (frame 62), illumination with UV light plus quantum dots (frame 64) and illumination with UV plus quantum dots plus background (frame 66). No optical filters were used.

### APPLICATIONS

Some of the many potential applications for a wireless CMOS biosensor such as the ones described above include applications for microarrays as well as for implantable biosensors. Microarrays may include DNA, RNA, protein and other biological applications. Implantable biosensors may be useful in measuring cellular signals, signals involving viruses, bacteria, or other small molecules. In some embodiments, the implantable biosensor may also be a drug delivery device.

### DNA μ-Arrays for Diagnostics

Genetic diagnostic and screening applications are growing as the relationship between genetics and disease pathology is being elucidated. In addition, personalized medicine, the emerging field whereby drug treatment is partially determined by a patient's genetic makeup (i.e. Iressa, Herceptin, Bidil, etc.) will rely extensively on large scale genetic analysis. Drug trials are now beginning to include genetic screening, to determine the most effective patient profile. A biosensor such as the ones described herein may be useful for large scale genetic screening and analysis and for small scale genetic/diagnostic applications whereby arrays on the order of 10-100 are assayed.

The biosensor of the present invention is useful for both traditional microarray reader applications (e.g. cy3/cy5 labeled DNA), as well as GFP labeled protein. Since GFP labeling requires immersion in solution, a sensor such as the one described herein can be useful for this type of application. RNA binding proteins (RNAbp) can be fused to GFP to allow in-vivo tracking, immunoprecipitation, and also function as a label for microarray applications. The immunoprecipitated complex will be RNA+RNAbp+GFP and can be directly applied to an array, without the need for exogenously labeling with Cy3/Cy5.

Another way to use a CMOS sensor such as the ones described herein is to label DNA with Qdots (e.g., biotinylated DNA+streptavidin Qdots), rather than Cy3/Cy5 dyes. The quantum dots can be illuminated at any wavelength below their emission wavelength, and still fluoresce at a specific emission wavelength, as described above. Streptavidin labeled Qdots have been used on both protein and DNA microarrays. Applicants have shown that Qdots can be illuminated with UV and this UV light is not readily absorbed by the sensor. The Qdots then emit visible light, which can be detected by the sensor. This eliminates the need for an excitation filter.

### Protein μ-Arrays for Drug Development and Basic Research

Although DNA μ-arrays provide a wealth of information, proteins are the final effectors of physiological function, and provide the key to the vast majority of in-vitro diagnostics. Large scale protein arrays may enable advances in drug screening and interactions—by panning a drug against every protein in the system, both intended and potential side effects can be visualized and in basic research. Understanding protein-protein interactions helps elucidate key biological pathways and mechanisms of action. Furthermore, by knowing the binding kinetics of specific protein-protein interactions, the binding strength and specificity can be determined. These are characteristics that are relevant to both basic research and determining drug kinetics. Unlike DNA μarrays, which can be synthesized, proteins must be cloned and purified in a time consuming process. A biosensor such as the one described herein, could be combined with a method for patterning proteome arrays and used for studying binding kinetics.

After patterning of proteins on a surface, a GFP label sample is introduced. An evanescent wave only illuminates fluorophores within 1/10^{th} of a wavelength from the surface. Therefore, only fluorophores that are bound to the surface are illuminated. By monitoring the amount of light as a function of time, protein binding kinetics can be ascertained. Using GFP labeled proteins (or proteins labeled with a fluorophore), one can eliminate the need for labeled antibodies and multiple step procedures for imaging protein arrays. Kinetics can be visualized as well, since only one binding event is required, and real-time data can be taken in a hydrated environment. Since GFP must be hydrated, a fluid compatible sensor must be used. The biosensor of the present invention includes an outer layer to provide a fluid barrier and as such, can be placed in solution and used for assaying binding kinetics in a high throughput format. Additionally, chemical labeling (such as with FITC, or CY3/Cy5), can be used instead of GFP.

### Implantable Diagnostics/Monitoring Devices

Traditionally, flow cytometry or microscopy has been used for imaging cellular biosensors (cells with a reporter gene). In order to use these imaging techniques, cells must be placed into an in-vitro environment. The optimal biosensor would be a highly sensitive, real-time, continuous sensor of an organism, constantly circulating and being exposed to potential targets. The cellular sensors would then report back to a device which would relay information about the cells to the outside world. In order to accomplish this, the interfacing element (that communicates with the cellular sensors and relays the information) must be in the same environment as the cell, thus giving rise to the need for an implantable sensor. B cell/T cell sensors: Cells can be used as biosensors, since they have highly specific detection machinery in the form of antibodies and transmembrane receptors, internal signal amplification through a variety of signal transduction pathways, and reporting of the event via protein activation (e.g. phosphorylation) or gene activation through transcription factors. All cells can detect specific ligands, but only certain cells lend themselves to being engineered to bind to a specific target. The procedure of generating monoclonal antibodies is one in which cells are selected that bind to a specific target. The B cell hybridomas that produce antibodies also carry the antibodies on their surface. When the B cell receptors (BCR) bind to their target, the BCR complex activates an intracellular signaling pathway. This pathway activates an intracellular pathway, resulting in intracellular calcium release, and activation of transcription factors, such as API, NF-AT and NF-KB. T cells work in a similar fashion, although the T cell receptor must have the target presented by an MHC II complex. B cell hybridomas capable of antigen specific binding are engineered with a stable transfection of a reporter gene. Hybridomas are generated by fusing a myeloma cell line (AG8) with a B cell population from an immunized mouse.

Similar approaches can be applied to any biomarker that needs to be constantly sensed (i.e., glucose, insulin, cancer biomarkers, cardiac enzymes, etc), and may include sensing of optical biological signals, or signals obtained from an external dye marker. The biosensor of the present invention is small and wireless, making it a potential candidate for implantable applications. In one embodiment, the biosensor can detect and measure a reporter gene that produces GFP when the cell encounters a specific target. In another embodiment, cells may be labeled or filled with Qdots. The cells loaded with Qdots can migrate across a CMOS image sensor and be illuminated with UV light, and a picture taken. This can be used to track migration of cells. As pixel size and spacing becomes smaller and smaller, intracellular features may also be visualized.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions, illustrate the invention in a non limiting fashion.

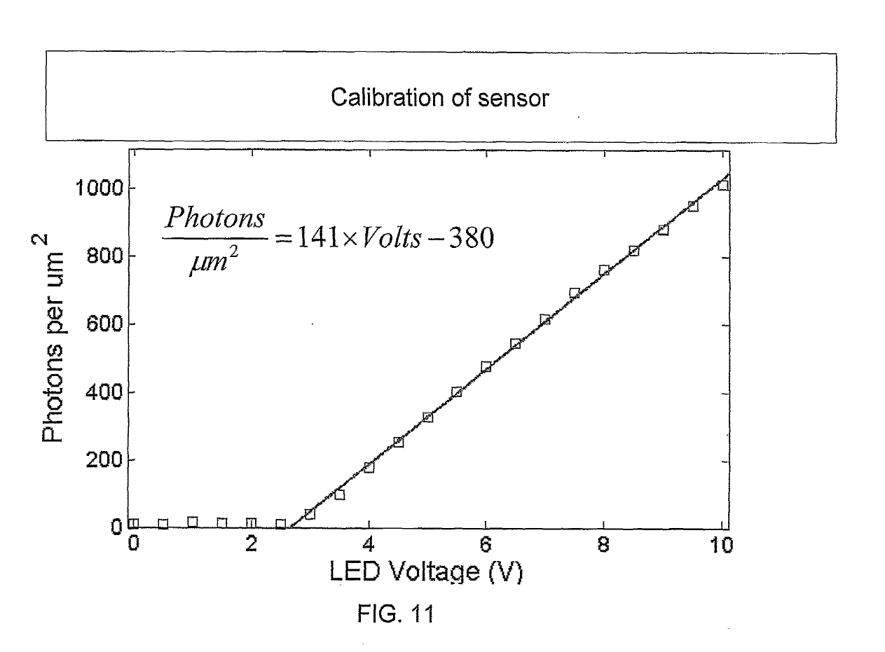

An LED was used to test the prototype sensor with 515 nm light. Reference is now made to FIG. 11, which is a calibration curve showing the number of photons incident on the sensor versus applied voltage. The LED emits light at around 2.7V of forward bias. At around 3V, the equivalent number of photons is about 40/um̂2/2.

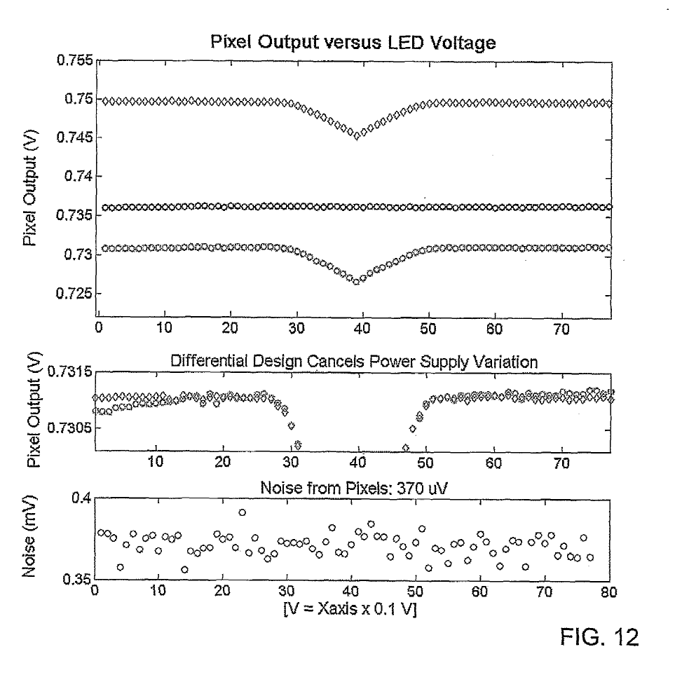

Reference is now made to FIG. 12, which is a graphical illustration of pixel output from ramping LED voltage. The LED was taken from 0-4V (indices 0-40), and then ramped down from 4V to 0 V (indices 40-80). This shows a response to light. Additionally, a signal of 40 photons/um̂2/s can be clearly seen.

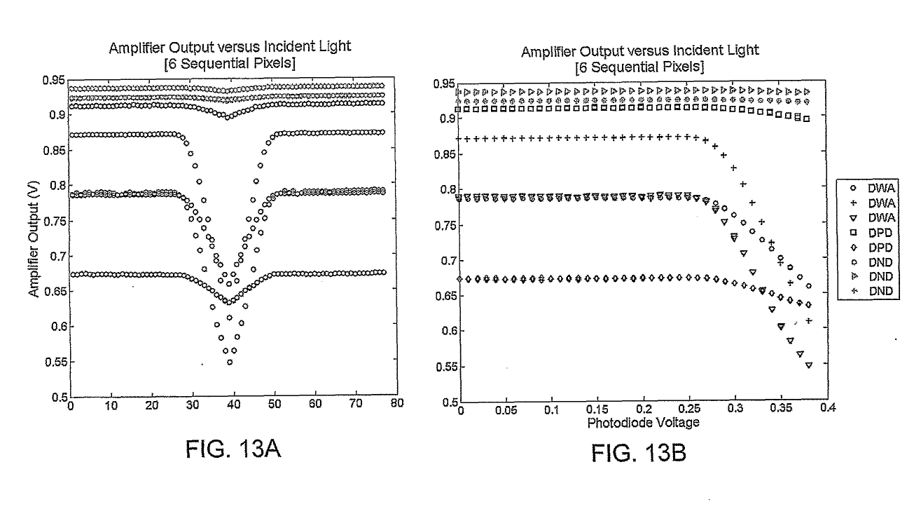

Reference is now made to FIGS. 13A and 13B, which are graphical illustrations of amplifier output versus incident light. The output of the amplifier is shown for different pixel types. Clearly the Nwell/Psub diodes have the greatest response.

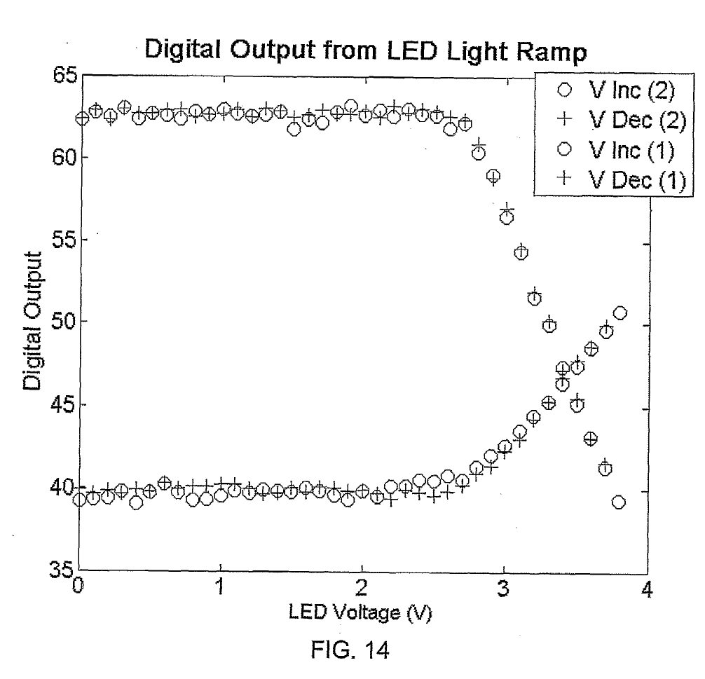

Reference is now made to FIG. 14, which is a graphical illustration of digital values from the amplifier output. Signals as low as 10 photons/um2/s can be detected.

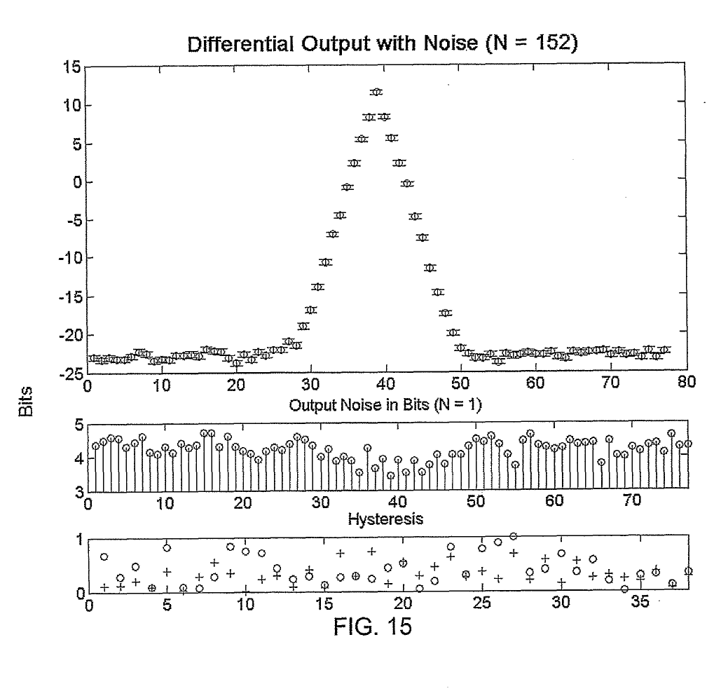

Reference is now made to FIG. 15, which is a graphical illustration of differential output with noise (noise=0.34 bits). On the X axis, 0-40 corresponds to 0-4 V, 41 to 80 corresponds to 3.9 V to 0 V. At index 30, approximately 40 photons/um²/s are imaged.

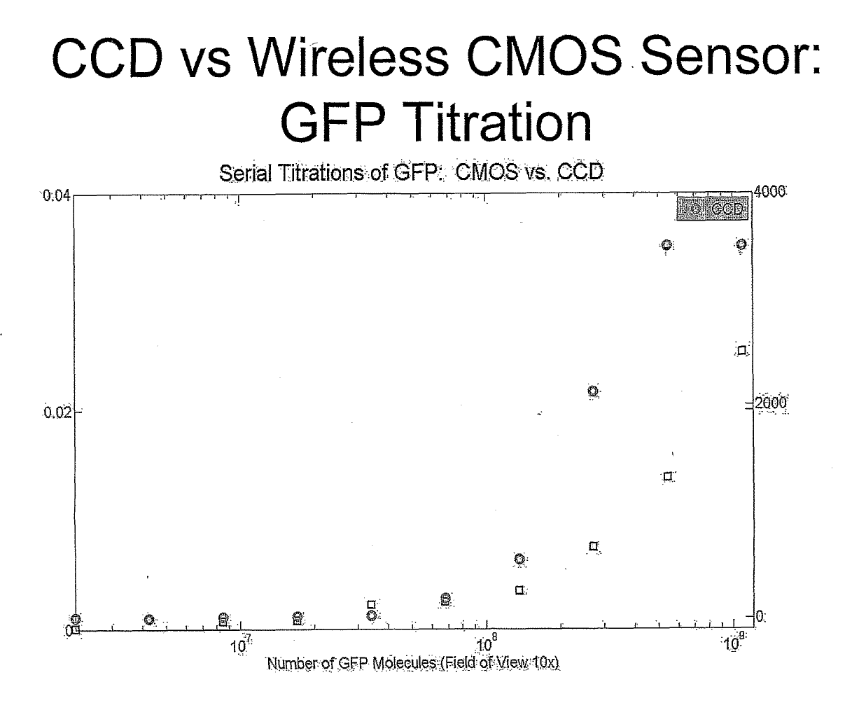

Reference is now made to FIG. 16, which is a graphical illustration comparing varying concentrations of GFP using the CMOS sensor of the present invention versus a CCD camera. Serial dilutions of GFP were made and imaged with both a CCD and the CMOS sensor. The CCD) output is the digital output (1 to 4096), and the wireless CMOS sensor output is the amplifier output (before digital conversion). For the CCD, the higher the amount of light, the greater the digital value. For the wireless sensor, the greater the amount of light, the greater the deviation form baseline (i.e. lower voltage). PBS is added as a negative control. Serial dilutions of GFP are then imaged. Both sensors can image GFP to about 10̂7 molecules. For reference, a 125×125 um̂2 area on a microarray slide can contain up to 10⁸ molecules, so the sensitivity of the sensor of the present invention approaches the sensitivity needed to detect spots on a microarray.

While certain features of the invention have been illustrated and described herein, many modifications, substitutions, changes, and equivalents may occur to those of ordinary skill in the art. It is, therefore, to be understood that the appended claims are intended to cover all such modifications and changes as fall within the true spirit of the invention.

1. A system for measuring a biological sample, the system comprising:
a sensor which provides an electrical output; an analog to digital converter in electrical communication with said sensor for converting said output into a digital signal, wherein at least said sensor and said analog to digital converter form a CMOS circuit; and
a processor for processing said digital signal.

2. The system of claim 1, wherein the sensor comprises a photodiode for converting photons obtained from interaction with the sample into electrons.

3. The system of claim 1, further comprising a wireless interface in communication with said sensor and said processor, said wireless interface configured to provide power to said sensor, and further configured to transmit and receive data from said processor.

4. The system of claim 3, wherein said wireless interface comprises an external antenna.

5. The system of claim 3, wherein said wireless interface comprises an integrated antenna, said integrated antenna integrated into a physical structure of said system.

6. The system of claim 1, wherein the sensor is integrated with an implantable device.

7. The system of claim 6, wherein said implantable device is a stent, and wherein said sensor is integrated with said stent.

8. The system of claim 6, wherein said implantable device is a drug delivery device, and said sensor is integrated with said drug delivery device.

9. The system of claim 1, wherein said sensor further comprises a flip-chip bonding scheme.

10. The system of claim 2, wherein said sensor further comprises multiple photodiodes arranged in a pixel array of photodiodes.

11. The system of claim 10, wherein said pixel array of photodiodes comprises a one-to-one correspondence with an array of the biological sample.

12. The system of claim 11, wherein a size of each pixel in said pixel array is less than 150 micrometers.

13. The system of claim 12, wherein a size of each pixel of said pixel array is approximately 120 micrometers×120 micrometers.

14. The system of claim 10, wherein said sensor further comprises an outer layer substantially surrounding said pixel array, said outer layer providing a fluid barrier between electrical components of said sensor and the biological sample.

15. The system of claim 2, further comprising an evanescent illumination system said illumination system comprising a prism positioned beneath said sensor for introducing light, wherein said at least one photodiode is configured for receiving photons via said evanescent illumination system.

16. The system of claim 2, wherein said at least one photodiode is selected from the group consisting of an N-plus P-sub diode, an N-well P-sub diode, a P-plus N-well P-sub diode, and an N-plus P-well diode.

17. The system of claim 16, wherein all of said diodes are used.

18. The system of claim 10, wherein each pixel of said pixel array comprises a sensor photodiode and a reference photodiode.

19. The system of claim 18, wherein said reference photodiode is covered with metal.

20. The system of claim 18, wherein each pixel of said pixel array further comprises a first source follower, a second source follower, and a hold capacitor, and wherein said first source follower is for applying a sample and hold operation onto said hold capacitor for storage, said second source follower is for transmitting said stored hold operation to said processor.

21. The system of claim 1, further comprising a microarray of the biological sample, wherein said sensor is positionable in close proximity with said microarray.

22. The system of claim 21, further comprising multiple photodiodes arranged in a pixel array of photodiodes wherein a size of each pixel ranges from less than the size of a spot on the microarray to a maximum of the pitch between spots on the microarray.

23. The system of claim 21, wherein said microarray is selected from the group consisting of: a protein array, a DNA array, an RNA array, a cellular array, an array including a virus, an array including a bacteria, and an array including small molecules.

24. The system of claim 1, wherein the biological sample is tagged with quantum dots, the system further comprising a UV illuminator, said obtained photons obtained from illumination of said quantum dots by said UV illuminator.

25. The system of claim 1, wherein said sensor is implantable in a human body.

26. The system of claim 25, wherein said obtained photons are obtained from optical signals in the body.

27. The system of claim 26, wherein said optical signals include cellular signals.

28. The system of claim 26, wherein said optical signals include signals from a biological marker.

29. The system of claim 25, wherein said obtained photons are obtained from an external dye marker.

30. The system of claim 3, further comprising a light source powered by said wireless interface.

31. The system of claim 14, wherein said outer layer is a biocompatible material.

32. A sensor for identifying an interaction in a microarray, the sensor comprising:
a pixel array of photodiodes, wherein a size of each pixel of said pixel array corresponds to said microarray; and
an outer layer substantially surrounding said pixel array, said outer layer providing a fluid barrier between electrical components of said sensor and said biological sample.

33. The sensor of claim 32, wherein a size of each pixel ranges from less than the size of a spot on the microarray to a maximum of the pitch between spots on the microarray.

34. The sensor of claim 32, wherein a size of each pixel is less than 150 micrometers.

35. The sensor of claim 34, wherein each pixel of said pixel array is approximately 120 micrometers×120 micrometers in size.

36. The sensor of claim 32, wherein said sensor is implantable within a human body.

37. The sensor of claim 32, wherein said outer layer is a biocompatible material.

38. The sensor of claim 32, wherein said pixel array of photodiodes comprises at least one photodiode selected from the group consisting of an N-plus P-sub diode, an N-well P-sub diode, and a P-plus N-well P-sub diode.

39. The system of claim 38, wherein all of said diodes are used.

40. The sensor of claim 32, wherein each pixel of said pixel array comprises a sensor photodiode and a reference photodiode.

41. The sensor of claim 40, wherein said reference photodiode is covered with metal.

42. The sensor of claim 32, further comprising an analog/digital converter in electrical communication with said photodiodes.

43. The sensor of claim 42, wherein each pixel of said pixel array further comprises a first source follower, a second source follower, and a hold capacitor, and wherein said first source follower is for applying a sample and hold operation onto said hold capacitor for storage, said second source follower is for transmitting said stored hold operation to said processor.

44. The sensor of claim 42, wherein said photodiodes and at least said analog/digital converter form a CMOS circuit on said sensor.

45. A method for measuring a sample, comprising:
providing a wireless CMOS biosensor comprising a pixel array of photodiodes;
providing a biological sample;
tagging said biological sample with a fluorescent label;
placing said biosensor proximal to said biological sample;
illuminating said biosensor and said biological sample, wherein said illuminating causes said tagged biological sample to emit photons;
converting said photons into an electrical signal using said CMOS biosensor; and
wirelessly receiving said electrical signal, said electrical signal being representative of an amount of said tagged biological sample.

46. The method of claim 45, wherein said sample is a biological sample.

47. The method of claim 46, wherein said biological sample is a DNA sample.

48. The method of claim 46, wherein said biological sample is a protein sample.

49. The method of claim 45, wherein said placing said biosensor proximal to said biological sample comprises placing said biosensor in solution.

50. The method of claim 45, wherein said placing said biosensor proximal to said biological sample comprises placing said biosensor in contact with said biological sample.

51. The method of claim 45, wherein said placing said biosensor proximal to said biological sample comprises providing said biological sample as a microarray, and placing said biosensor within a distance which is several times a spot size of the microarray.

52. The method of claim 45, wherein said tagging comprises tagging with quantum dots.

53. The method of claim 45, wherein said illuminating comprises evanescently illuminating.
